(19) United States
(12) Patent Application Publication
(10) Pub. No.: US 2023/0019183 A1
(43) Pub. Date: Jan. 19, 2023

(54) TOOL ASSEMBLY

(71) Applicant: Meyric Kirk Rogers, Lancaster, PA (US)

(72) Inventor: Meyric Kirk Rogers, Lancaster, PA (US)

(21) Appl. No.: 17/379,396

(22) Filed: Jul. 19, 2021

(51) Int. Cl. A01B 1/02; B25G 1/04

(52) U.S. Cl. CPC A01B 1/026; B25G 1/04; A01B 1/06

(57) ABSTRACT

An improved assembly is described. The assembly includes a shaft affixed on a first side to a first handle and affixed to a tool on a second side. A first end of a continuous cord is affixed to the tool at a first location and a second end of the continuous cord is affixed to the tool at a second location. A second handle is affixed to a loop formed by the continuous cord. During use, a user grasps both handles, places the tool at a base of a payload, and pushes the assembly to load the payload onto the tool. By bending the users knees and not putting undue strain on the users back, the user may utilize the handles to lift and move the payload to a desired location.

### FIELD OF THE EMBODIMENTS

The field of the invention and its embodiments relate to an improved tool assembly. In particular, the field of the invention and its embodiments relate to an improved tool assembly that allows a user to lift a heavy load without placing undue physical strain on the user doing the lifting.

### BACKGROUND OF THE EMBODIMENTS

Spades, shovels, and similar tools are used for the manipulation of snow, sand, soil, and other materials. However, use of such tools often results in serious physiological strain to the user. For example, in ordinary use, the common snow shovel places very large loads on the muscles of the back, and necessitates highly coordinated movement while under these high loads. The dead weight of a shovelful of wet snow is required to be lifted at arm's length, typically to hip level, while the body is bent forward and adds to the load on the back. Such physiological strain results in discomfort to the user and results in a necessity for a high level of muscular strength by the user to move the payload. Such strain creates significant risks of serious and chronic injury to the spine and associated musculature of the user. Thus, what is needed is a new lifting instruments that can lift heavy loads without placing undue physical strain on the person doing the lifting.

### REVIEW OF RELATED ART

U.S. Pat. No. 4,881,332 describes an attachment for a shovel or similar tool that relieves the worker of the back muscle and vertebral strain normally attendant with shoveling. The shovel aid features an elongate stem pivotally attached to the shovel handle, so that the material being shoveled may be loaded upon the shovel head, lifted, and carried sideways to be deposited, all without lifting forces upon the shovel by the hands, and without curvature of the back and spine. The shovel lifting aid may be used also with snow shovels, hoes and the like.

U.S. Pat. No. 5,133,582 describes a two-handled shovel in which the shorter shaft of the secondary or lift handle is connected at its lower terminal end to the primary handle at a point proximal its connection with the blade through a connection which enables essentially unlimited rotary direction of the primary handle with respect to the secondary handle during operation. Normally such attachment mechanism is accomplished by the provision of a rotary bushing.

WO 1992/017049 describes a self-raising spade that is designed to enable material to be moved from a low level and raised to a working height, without requiring the user to bend or stoop. The action does not require the user to take the weight of the load whilst in a bent posture, therefore reducing the risk of physical injury. The essential feature of this invention is the triangular support leg upon which the load rises to a selected height, this being brought about by the natural backwards motion of the user, the leg returning automatically towards the shaft on discharge of the spade towards the side.

U.S. Pat. No. 5,669,651 describes an attachment for a shovel that aids the user in lifting a fully loaded shovel blade without incurring back strain. The attachment is pivotally mounted to the main shovel shaft near the blade and has a cambered portion remote from the shaft. A foot pedal at the distal end of the cambered portion enables the user to apply his body weight so as to rock the attachment along the cambered portion and lift the loaded shovel blade.

Various tools and tool assemblies exist. However, their means of operation are substantially different from the present disclosure, as the other inventions fail to solve all the problems taught by the present disclosure.

### SUMMARY OF THE EMBODIMENTS

The present invention and its embodiments relate to an improved tool assembly. In particular, the present invention and its embodiments relate to an improved tool assembly that allows a user to lift a heavy load without placing undue physical strain on the user doing the lifting.

A first embodiment of the invention describes an assembly. The assembly generally includes a shaft, a continuous cord, a tool, a first handle component, and a second handle component. The shaft has a first side disposed opposite a second side. The first side of the shaft is affixed to the first handle component. The second side of the shaft is affixed to the tool. The tool may be a blade, a spade, or a pitchfork, among other examples not explicitly listed herein.

The continuous cord has a first end disposed opposite a second end. The first end of the continuous cord is affixed to the tool at a first location and the second end of the continuous cord is affixed to the tool at a second location. The first location differs from the second location. More specifically, the first location is equidistant from the second location.

In some examples, the continuous cord is single stranded. In other examples, the continuous cord is multi-stranded. The second handle component is affixed to the continuous cord such that the continuous cord is configured to form a loop between the first location, the second location, and the second handle. In further examples, the continuous cord is adjustable in length and comprises a first attachment means configured to be affixed to a second attachment means. It should be appreciated that these attachment means may be any means known to one having ordinary skill in the art.

In an example, the shaft further comprises an adjustment component comprising a plurality of openings. The adjustment component is configured to adjust a length of the shaft to accommodate users of varying heights. Further, the loop is affixed to a stopper component. An opening of the plurality of openings is configured to receive the stopper component therein.

It should be appreciated that the loop is adjustable. In a first example, the shaft further comprises a hook element. A gape of the hook element faces the first handle component. In this first example, the loop is affixed to the hook element and the hook element is movable on the shaft to adjust a length of the loop formed by the continuous cord. In a second example, the shaft further comprises a clamp component such that the loop is received by the clamp component. In this second example, the clamp component is movable on the shaft to adjust a length of the loop formed by the continuous cord. In a third example, linear cord ends may be affixed to the clamp component.

A second embodiment of the invention describes a kit configured to be added/retrofitted to a conventional tool implement. The conventional tool implement may be a long-handled tool and generally includes a shaft disposed between a first handle component and a tool. The conventional tool implement may be a shovel, a snow shovel, a hoe, a gardening fork, a spade, or a pitchfork, among other examples. The kit includes a torque bar, a flexible cord, a second handle component, and a cord adjuster/hook element. The torque bar is attachable to the shaft and is configured to create two fixed points. The flexible cord is receivable by the torque bar at the two fixed points and is affixed to the second handle component. The flexible cord may include a material such as a synthetic material, a metal material, or a natural material, among other materials not explicitly listed herein. The cord adjuster/hook element is attachable to the shaft and is configured to adjust a length of the flexible cord.

The flexible cord forms a loop between the two fixed points and the second handle component. Moreover, the second handle component comprises an opening configured to receive the loop therein such that the loop is slidable within the second handle component.

In general, the present invention succeeds in conferring the following benefits and objectives.

It is an objective of the present invention to provide an improved tool assembly.

It is an objective of the present invention to provide an improved tool assembly that allows a user to lift a heavy load without placing undue physical strain on the user doing the lifting.

It is an objective of the present invention to provide a kit that serves as an attachment to a traditional long-handled tool.

It is an objective of the present invention to provide a kit that serves as an attachment to a traditional long-handled tool, where the kit is easily attached to the long-handled tool and makes the long-handled tool ergonomic.

It is an objective of the present invention to provide a kit that serves as an attachment to a traditional long-handled tool, where the kit aids the user in lifting a heavy load using the long-handled tool.

### BRIEF DESCRIPTION OF THE DRAWINGS

FIG. 1 depicts a schematic diagram of a tool assembly, according to at least some embodiments disclosed herein.

FIG. 2 depicts a schematic diagram of a tool assembly, according to at least some embodiments disclosed herein.

FIG. 3 depicts a schematic diagram of a tool assembly, according to at least some embodiments disclosed herein.

FIG. 4 depicts a schematic diagram of an adjustment component affixed to a shaft of a tool assembly, according to at least some embodiments disclosed herein.

FIG. 5 depicts a schematic diagram of an attachment means of a continuous cord of a tool assembly, according to at least some embodiments disclosed herein.

FIG. 6 depicts a schematic diagram of an attachment means of a continuous cord of a tool assembly, according to at least some embodiments disclosed herein.

FIG. 7 depicts a schematic diagram of a torque bar affixed to a shaft of a traditional long-handled tool, according to at least some embodiments disclosed herein.

FIG. 8 depicts a schematic diagram of a torque bar affixed to a shaft of a traditional long-handled tool, according to at least some embodiments disclosed herein

FIG. 9 depicts a schematic diagram of a torque bar and a clamp component affixed to a shaft of a traditional long-handled tool, according to at least some embodiments disclosed herein.

FIG. 10 depicts a schematic diagram of a torque bar and a clamp component affixed to a shaft of a traditional long-handled tool, according to at least some embodiments disclosed herein.

FIG. 11 depicts a schematic diagram of a second handle component of a tool assembly being configured to receive a continuous cord therein, according to at least some embodiments disclosed herein.

FIG. 12 depicts a block diagram of a three-dimensional (3D) printer system, according to at least some embodiments disclosed herein.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

The phrase “and/or,” as used herein in the specification and in the claims, should be understood to mean “either or both” of the elements so conjoined, i.e., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

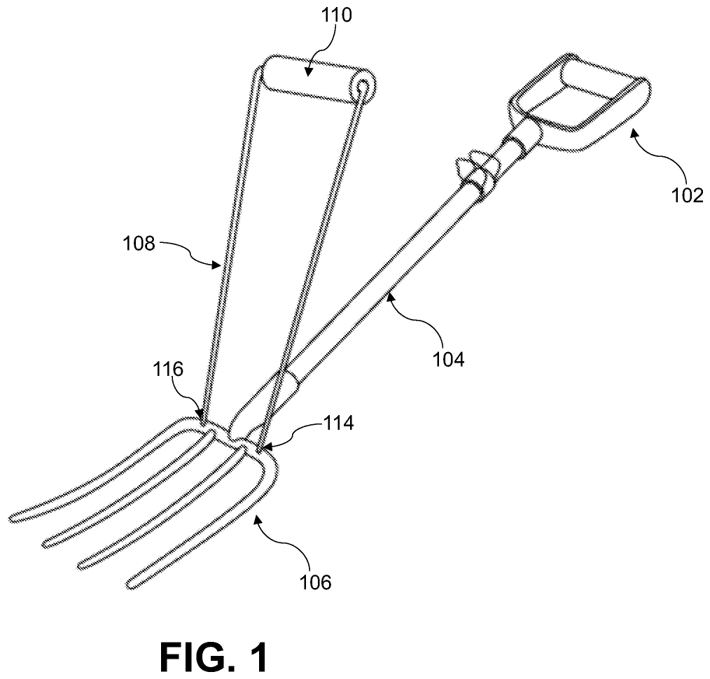

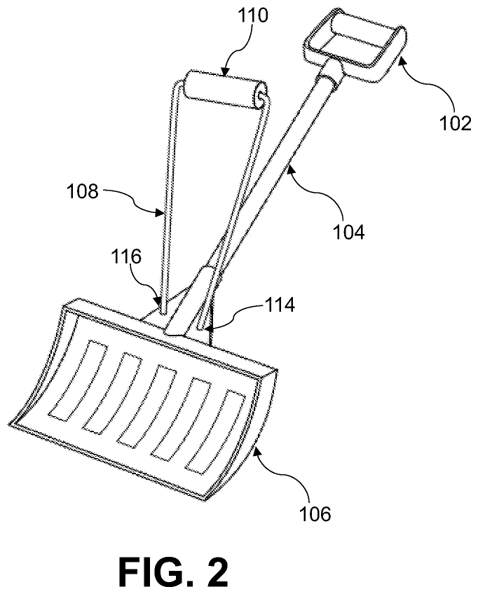

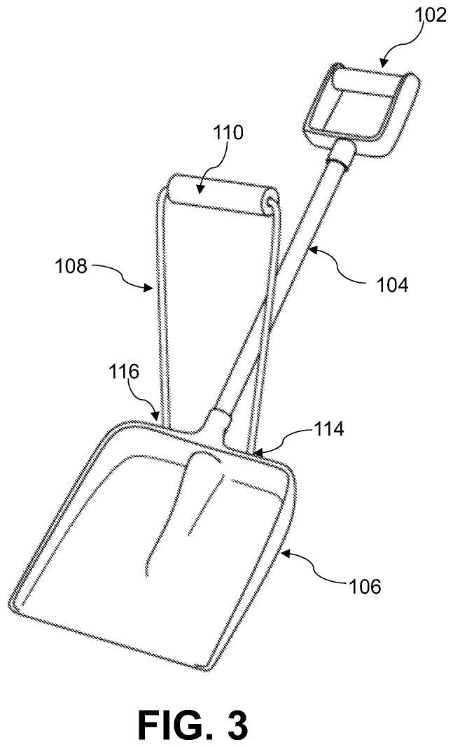

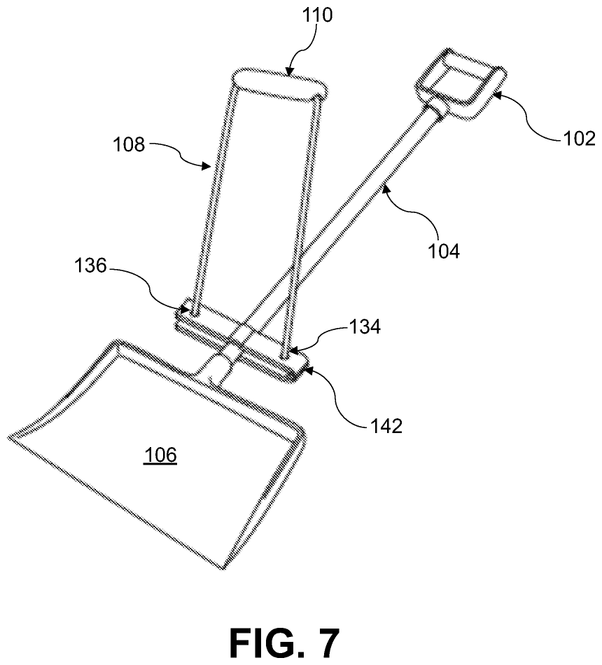

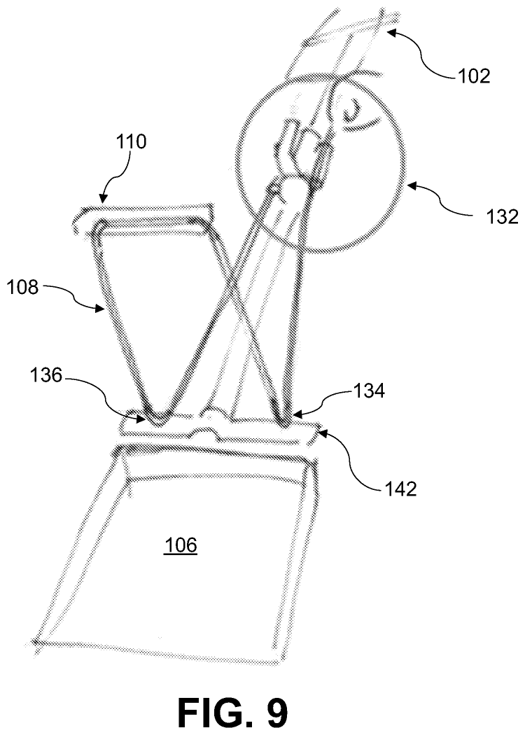

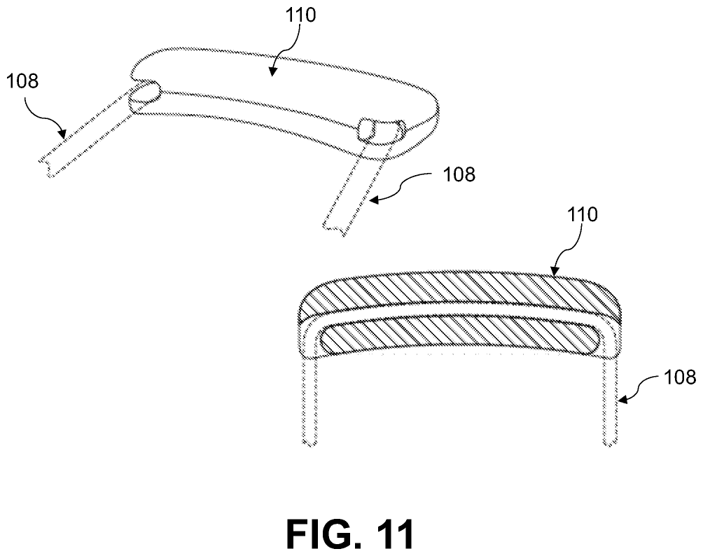

An assembly is described and depicted herein. The assembly generally includes a shaft 104 (of FIG. 1-FIG. 4 and FIG. 7-FIG. 8), a continuous cord 108 (of FIG. 1-FIG. 11), a tool 106 (of FIG. 1-FIG. 5 and FIG. 7-FIG. 9), a first handle component 102 (of FIG. 1-FIG. 5 and FIG. 7-FIG. 9), and a second handle component 110 (of FIG. 1-FIG. 5, FIG. 7, FIG. 9, and FIG. 11). The shaft 104 has a first side disposed opposite a second side. The first side of the shaft 104 is affixed to the first handle component 102. The second side of the shaft 104 is affixed to the tool 106. The tool 106 may be a blade, a spade, or a pitchfork, among other examples not explicitly listed herein.

As shown in at least FIG. 1-FIG. 3, the continuous cord 108 has a first end disposed opposite a second end. The first end of the continuous cord 108 is affixed to the tool 106 at a first location 114 and the second end of the continuous cord 108 is affixed to the tool 106 at a second location 116. The first location 114 differs from the second location 116. More specifically, the first location 114 and the second location 116 are each equidistant from a center point of the tool 106. In some examples, the continuous cord 108 is single stranded. In other examples, the continuous cord 108 is multi-stranded. Also, in some implementations of FIG. 1-FIG. 3, a simple clip element may be used to store the first handle component 102 when not in use.

Further, as shown in FIG. 11, the second handle component 110 may be a wooden dowel that comprises an opening disposed through a body of the second handle component 110. The opening of the second handle component 110 is configured to receive the continuous cord 108 therein such that the continuous cord 108 is slidable within the second handle component 110. As such, the continuous cord 108 is configured to form a loop between the first location 114, the second location 116, and the second handle 110. Moreover, in some examples, the first handle component 102 and/or the second handle component 110 may comprise a gripping portion (e.g., composed of a rubber or foam material) configured to be gripped by a user. In other examples, the first handle component 102 and/or the second handle component 110 may comprise a gripping component configured to be gripped by the user.

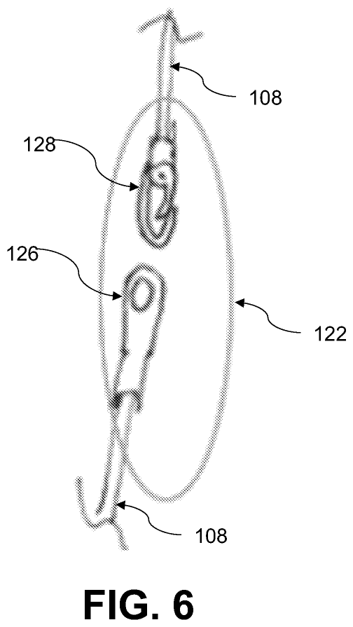

In some examples and as depicted in FIG. 6, a fixation component 122 comprises a first attachment means 128 located on a portion of the continuous cord 108 and a second attachment means 126 located on another portion of the continuous cord 108 such that the first means 128 engages the second attachment means 126 to form the continuous cord 108. Though the first means 128 is shown as a clamping component and the second attachment means 126 is shown as having an opening configured to receive the clamping component of the first means 128, other configurations are contemplated that achieve the same function. It should be appreciated that these attachment means may be any means or components known to one having ordinary skill in the art, such as snaps, male and female fasteners, hooks, clamps, a knot, securing ties, loops, clasps, etc. Moreover, though not depicted, FIG. 1-FIG. 4 may also include the first attachment means 124 in some embodiments.

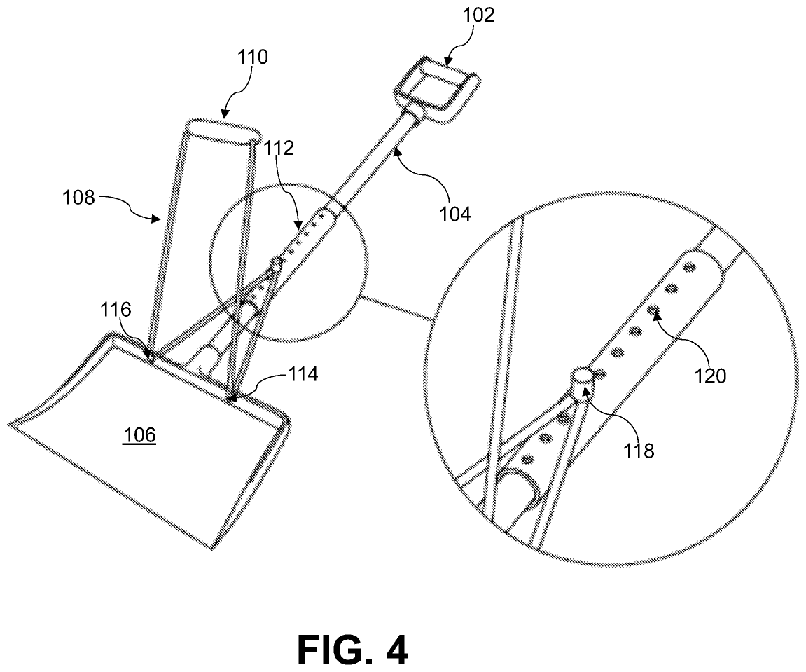

In an example, and as depicted in FIG. 4, the shaft 104 further comprises an adjustment component 112 comprising a plurality of openings 120. In examples, the openings 120 are equidistantly spaced from one another in a repetitive pattern. However, it should be appreciated that in some examples, the openings 120 may be spaced in any fashion from one another in a repetitive or randomized pattern. The adjustment component 112 allows for adjustment of a length of the shaft 104 to accommodate users of varying heights. In this example, the loop formed by the continuous cord 108 is affixed to a stopper component 118 (such as a pin). An opening of the plurality of openings 120 is configured to receive the stopper component 118 therein to secure the loop formed by the continuous cord 108 to the shaft 104.

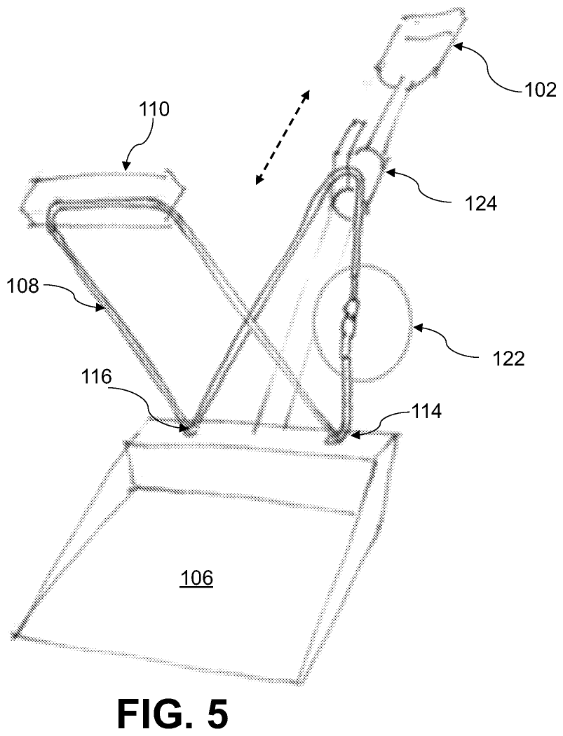

It should be appreciated that the loop formed by the continuous cord 108 is adjustable. In a first example, the shaft 104 further comprises a hook element 124, as shown in FIG. 5. A gape of the hook element 124 faces the first handle component 102. In this first example, the loop formed by the continuous cord 108 is affixed to the hook element 124 and the hook element 124 is movable on the shaft 104 to adjust a length of the loop formed by the continuous cord 108. The hook element 124 may also be included in FIG. 7, though not depicted in such figure. Additionally, an arrow is shown in FIG. 5 to indicate that the first attachment means 124 may slide up and down the shaft 104 to adjust a length of the continuous cord 108.

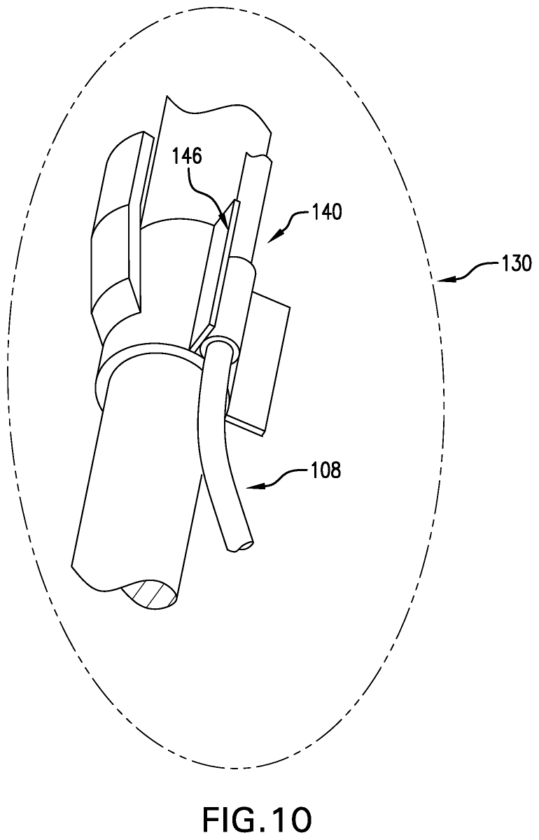

In a second example, the shaft 104 further comprises a clamp component 130 or a clamp component 132, as shown in FIG. 9 and FIG. 10, such that the loop formed by the continuous cord 108 is received by the clamp component 130 or the clamp component 132. In this second example, the clamp component 130 or the clamp component 132 is movable on the shaft 104 to adjust a length of the loop formed by the continuous cord 108. As shown in FIG. 10, the clamp component 130 may include an opening configured to receive the loop formed by the continuous cord 108 therein. Further, the clamp component 130 may also include a first wall 140 located on a first side of the opening and a second wall 146 located on the second side of the opening.

In a third example, the shaft 104 further comprises a spring loaded component (not shown) that is configured to utilize a spring to adjust the length of the loop formed by the continuous cord 108. In a fourth example, the shaft 104 further comprises a winding component (not shown) that is configured to wind the continuous cord 108 to adjust the length of the loop formed by the continuous cord 108. In a fifth example, the shaft 104 further comprises a lever (not shown) that is configured to decrease the length of the loop formed by the continuous cord 108 upon a first action executed on the lever in a first direction and increase the length of the loop formed by the continuous cord 108 upon a second action executed on the lever in a second direction, where the first direction is opposite the second direction. It should be appreciated that these examples are provided for illustrative purposes only. Other examples are contemplated by Applicant which function similarly as the ones described herein.

In a further embodiment of the invention, a kit is described. The kit is configured to be added or retrofitted to any conventional tool implement, such as a long-handled tool. The tool implement may include a shaft disposed between a first handle component and a tool. The shaft may include a metal material, a wooden material, and/or a plastic material, among other materials not explicitly listed herein. In examples, the tool implement may include: a shovel, a snow shovel, a hoe, a gardening fork, a spade, and/or a pitchfork, among other examples not explicitly listed herein. Generally, the kit includes a torque bar 142 (of FIG. 7-FIG. 9), a flexible cord (e.g., the continuous cord 108), and/or a cord adjuster (e.g., the hook element 124 and/or the clamp component 130).

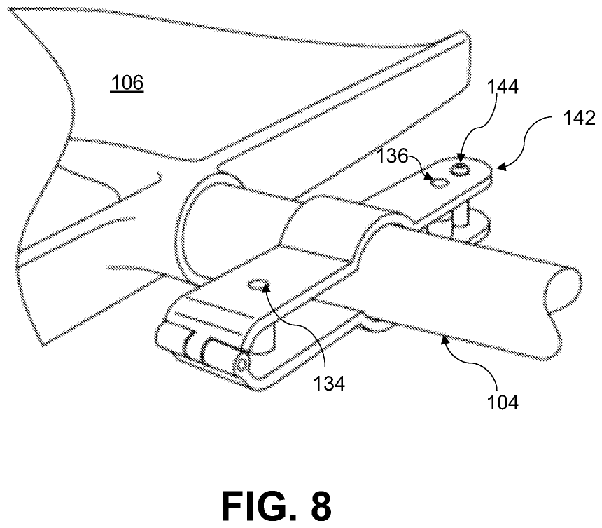

The torque bar 142 is attachable to the shaft 104 of the tool implement and is easily removable from the tool implement. The torque bar 142 is configured to create two fixed points. The torque bar 142 may comprise a metal or a plastic material, among others not explicitly listed herein. As shown in FIG. 7 and FIG. 8, the torque bar 142 may be substantially planar or planar in shape. As shown in FIG. 8, the torque bar 142 may include a hinge on one side of the torque bar 142 and may include protrusion in the center of the torque bar 142 such that the shaft 104 of the tool implement may be received therein. In some examples, and as shown in FIG. 8, the torque bar 142 is attachable to the shaft 104 of the tool implement by one or more fixation means 144, such as screws, pins, or bolts.

The flexible cord (e.g., the continuous cord 108) is receivable by the torque bar 142 at a first location 134 and at a second location 136, as shown in FIG. 7-FIG. 9. The flexible cord (e.g., the continuous cord 108) may comprise any flexible material, such as a synthetic material, a metal material, and/or a natural material, among other materials not explicitly listed herein. In preferred examples, the flexible cord (e.g., the continuous cord 108) comprises a ¼″ nylon cord.

Further, the cord adjuster (e.g., the hook element 124 and/or the clamp component 130) is attachable to the shaft 104 of the tool implement and is easily removable from the tool implement. The cord adjuster (e.g., the hook element 124 and/or the clamp component 130) may be used to adjust a length of the flexible cord (e.g., the continuous cord 108). Though the torque bar 142 is shown and described with certain shapes and sizes, any shape or size may be used.

During use of the assembly described herein, a user may grasp both the first handle component 102 and the second handle component 110. In some examples, the second handle component 110 may be grasped by the dominant hand of the user. Next, the user may place the tool 106 at a base of a payload (e.g., snow, gravel, sand, mulch, etc.). The user may then push the assembly to load the payload onto the tool 106. By bending the users knees and not putting undue strain on the users back, the user may utilize the first handle component 102 and the second handle component 110 to lift and move the payload to a desired location. As such, the assembly described herein reduces the physical strain for the user to move a heavy payload.

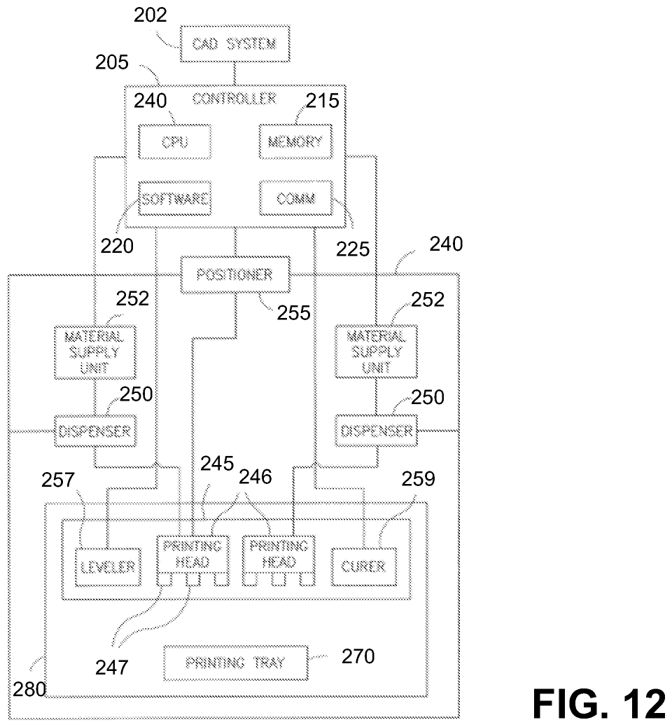

FIG. 12 depicts a block diagram of a three-dimensional (3D) printer system, according to at least some embodiments disclosed herein. The 3D printer system of FIG. 12 described herein may be used to three-dimensionally print components and add these components to a traditional tool or shovel to create the tool assembly described herein. The 3D printer system of FIG. 12 may include, for example, a CAD module 202, a controller 205, and a printing apparatus 240. The controller 205 includes numerous components, such as: a central processing unit (CPU) 250, a memory unit 215, software code 220, and a communications unit 225. The controller 205 prepares digital data that characterizes a 3D object for printing and controls the operation of the apparatus, which may include, for example, a processor, the memory unit 215, the software code 220, and the communications unit 225. Other configurations may be used for a controller or control unit. Control functionality may be spread across units, and not all control functionalities may be within the system of FIG. 12. For example, a separate unit, such as a personal computer or workstation may be used.

The communications unit 225 may enable the transfer of data and instructions between the controller 205 and the CAD module 202, between the controller 205 and the printing apparatus 240, and/or between the controller 205 and other system elements. The controller 205 may be suitably coupled and/or connected to various components of the printing apparatus 240. In examples, the printing apparatus 240 may include positioner(s) 255, material dispenser(s) 250, material supply unit(s) 252, and a printing sub-system 280. The printing sub-system 280 may include a printing box 245 and a printing tray 270. The printing box 245 may include printing head(s) 246, printing nozzle(s) 247, leveler(s) 257, curer(s) 259, and other suitable components.

The positioner 155, or other suitable movement devices, may control the movement of the printing head 245. The leveler 257 may include, for example, a roller or other suitable leveling mechanism. The printing head 245 may be, for example, an ink jet head or other suitable printing head. Moreover, the controller 205 may utilize computer object data (COD) representing an object or a model, for example, CAD data in STL format. Other data types or formats may be used, according to at least some embodiments described herein. The controller 205 may convert such data to instructions for the various units within 3D printer system to print a 3D object, such as components of the tool assembly described herein.

In a first embodiment, the controller 205 may be located inside the printing apparatus 240. In a second embodiment, the controller 205 may be located outside of the printing apparatus 240. In another example, the controller 205 may be located outside of the printing system and may communicate with the printing system, for example, over a wire and/or using wireless communications. In some embodiments, the controller 205 may include a CAD system or other suitable design system. In alternate embodiments, the controller 205 may be partially external to the 3D printer system. For example, an external control or processing unit (e.g., a personal computer, workstation, computing platform, or other processing device) may provide some or all of the printing system control capability. In some embodiments, a printing file or print data may be prepared and/or programmed, for example, by a computing platform connected to the 3D printer system. The printing file may be used to determine, for example, the order and configuration of deposition of building material via, for example, movement of and activation and/or non-activation of one or more nozzles 247 of the printing head 245, according to the 3D object to be built.

The controller 205 may be implemented using any suitable combination of hardware and/or software. In some embodiments, the controller 205 may include, for example, the processor, the memory 215, and the software or operating instructions 220. The processor may include conventional devices, such as a Central Processing Unit (CPU), a microprocessor, etc. The memory 215 may include conventional devices, such as Random Access Memory (RAM), Read-Only Memory (ROM), or other storage devices, and may include mass storage, such as a CD-ROM or a hard disk. The controller 205 may be included within, or may include, a computing device such as a personal computer, a desktop computer, a mobile computer, a laptop computer, a server computer, etc. The controller 205 may be of other configurations, and may include other suitable components.

According to some embodiments of the present invention, the material supply unit(s) 252 may supply building materials to the printing apparatus 240. Building materials may include any suitable kind of object building material. In some embodiments of the present invention, the building materials used for construction of the 3D object are in a liquid form. In an exemplary embodiment of the present invention, the modeling and/or support materials used are photopolymers that may contain material curable by electro-magnetic radiation and/or electron beams etc. The materials may come in different forms, textures, colors, etc. Other suitable materials or combinations of materials may be used. For example, printing an object may include dispensing modeling and/or support materials on a layer by layer basis according to a predetermined configuration, from a plurality of nozzles on the apparatus' printing head. The building material(s) may be dispensed at a given temperature in a fluid state to form a layer, and after dispensing each layer may optionally be cured by, for example, a source of electromagnetic radiation. The building material(s) may solidify as a result of curing and subsequent cooling.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. An assembly comprising:
a shaft having a first side disposed opposite a second side, wherein the first side of the shaft is affixed to a first handle component, and wherein the second side of the shaft is affixed to a tool;
a continuous cord having a first end and a second end, wherein the first end of the continuous cord is affixed to the tool at a first location, wherein the second end of the continuous cord is affixed to the tool at a second location, and wherein the first location differs from the second location; and
a second handle component affixed to the continuous cord.

2. The assembly of claim 1, wherein the tool is selected from the group consisting of: a blade, a spade, and a pitchfork.

3. The assembly of claim 1, wherein each of the first location and the second location are equidistant from a center location of the tool.

4. The assembly of claim 1, wherein the continuous cord is single stranded.

5. The assembly of claim 1, wherein the continuous cord is multi-stranded.

6. The assembly of claim 1, wherein the continuous cord forms a loop between the first location, the second location, and the second handle.

7. The assembly of claim 6, wherein the shaft further comprises an adjustment component comprising a plurality of openings, and wherein the adjustment component is configured to adjust a length of the shaft to accommodate varying heights of users.

8. The assembly of claim 7, wherein the loop is affixed to a stopper component, and wherein an opening of the plurality of openings is configured to receive the stopper component therein to affix the loop of the continuous cord to the adjustment component.

9. The assembly of claim 6, wherein the loop is adjustable.

10. The assembly of claim 9, wherein the shaft further comprises a hook element, and wherein a gape of the hook element faces the first handle component.

11. The assembly of claim 10, wherein the loop is affixed to the hook element, and wherein the hook element is movable on the shaft to adjust a length of the loop.

12. The assembly of claim 1, wherein the continuous cord comprises a first attachment means configured to be affixed to a second attachment means.

13. The assembly of claim 9, wherein the shaft further comprises a clamp component, wherein the loop is received by the clamp component, and wherein the clamp component is movable on the shaft to adjust a length of the loop.

14. A kit configured to be added to a conventional long-handled tool, the conventional long-handled tool comprising a shaft disposed between a first handle component and a tool, the kit comprising:
a torque bar attachable to the shaft and configured to create two fixed points;
a second handle component;
a flexible cord receivable by the torque bar at the two fixed points and affixed to the second handle component; and
a cord adjuster attachable to the shaft to adjust a length of the flexible cord.

15. The kit of claim 14, wherein the flexible cord forms a loop between the two fixed points and the second handle component.

16. The kit of claim 15, wherein the second handle component comprises an opening configured to receive the loop therein such that the loop is slidable within the second handle component.

17. The kit of claim 14, wherein the tool implement is selected from the group consisting of: a shovel, a snow shovel, a hoe, a gardening fork, a spade, and a pitchfork.

18. The kit of claim 14, wherein the flexible cord comprises a material selected from the group consisting of: a synthetic material, a metal material, and a natural material.

19. The kit of claim 14, wherein the torque bar comprises a material selected from the group consisting of: a metal material and a plastic material.

20. The kit of claim 14, wherein the shaft comprises a material selected from the group consisting of: a metal material, a wooden material, and a plastic material.
